(19) United States
(12) Patent Application Publication
(10) Pub. No.: US 2023/0420811 A1
(43) Pub. Date: Dec. 28, 2023

(54) Method for Producing a Lithium-Ion Battery Cell, and Lithium-Ion Battery Cell

(71) Applicant: Bayerische Motoren Werke Aktiengesellschaft, Muenchen (DE)

(72) Inventors: Martin GOUVERNEUR, Berlin (DE); Wonsup HAN, Suwon-Si, Kwonsun-Ku (KR); Hyunchul ROH, Muenchen (DE)

(21) Appl. No.: 18/036,005

(22) PCT Filed: Oct. 8, 2021
(86) PCT No.: PCT/EP2021/077813

§ 371 Date: May 9, 2023

(30) Foreign Application Priority Data
Nov. 20, 2020 (DE) 10 2020 130 686.5

(51) Int. Cl. H01M 50/557; H01M 50/528; H01M 50/538

(52) U.S. Cl. CPC H01M 50/557; H01M 50/528; H01M 50/538; H01M 2220/20

(57) ABSTRACT

A method for producing a lithium-ion battery cell includes providing a connection plate on a battery-cell housing of the lithium-ion battery cell and a connecting pin. The connection plate has an opening for the connecting pin and further includes a coefficient of thermal expansion greater than that of the connecting pin. The connection plate is heated and the connecting pin is inserted into the opening in the connection plate. When the connection plate cools down, the connecting pin is fixed in the connection plate. The connecting pin is guided through an opening in the battery-cell housing and is connected to a current collector of at least one negative electrode of the lithium-ion battery cell, thereby electrically connecting the current collector to the connection plate. A lithium-ion battery cell that can be produced by the method is also described.

### BACKGROUND AND SUMMARY

The invention relates to a method for producing a lithium-ion battery cell and a lithium-ion battery cell which can be produced using the method.

High-voltage batteries, which typically have one or more battery modules each having a plurality of battery cells, are used in electrically driven motor vehicles such as electric vehicles, hybrid or plug-in hybrid vehicles. Owing to the high energy density that can be achieved, lithium-ion battery cells in particular are used in motor vehicles. Here and in the text which follows, the term “lithium-ion battery cell” is used synonymously for all designations conventional in the prior art for lithium-containing galvanic elements and cells, such as, for example, lithium battery, lithium cell, lithium-polymer cell and lithium-ion rechargeable battery. In particular, rechargeable batteries (secondary batteries) are included. The lithium-ion battery cell can also be a solid-state battery, for example a ceramic or polymer-based solid-state battery.

The electrode active materials of a lithium-ion battery cell are generally applied to foils comprising aluminum or copper, wherein the foils are each connected to the current collector. The current collectors can be connected to connection plates on the outer side of a battery cell housing of the lithium-ion battery cell, where the connection plates form the positive and negative terminal of the battery cell. In the case of a lithium-ion battery cell, the positive electrode (cathode) generally has a current collector comprising aluminum, and the negative electrode (anode) has a current collector comprising copper. Owing to the electrochemical properties, copper may be used instead of aluminum for the current collector at the negative electrode.

One object of this disclosure is to describe a method for producing a lithium-ion battery cell, in which the current collector of the negative electrode is connected in a comparatively simple and time-saving manner to a connection plate on the battery cell housing, where the contact resistance of the connection is low. Furthermore, a lithium-ion battery cell which can be produced using the method is described.

These objects may be achieved by a method and a lithium-ion battery cell in accordance with the independent patent claims. Advantageous embodiments and developments of the invention can be gleaned from the dependent claims.

In accordance with one embodiment of the disclosure, in the method a current collector of at least one negative electrode of the lithium-ion battery cell is connected to a connection plate on a battery cell housing of the lithium-ion battery cell. In the method, a connecting pin and the connection plate having an opening for the connecting pin are provided, where the connection plate comprises a material having a higher coefficient of thermal expansion than the connecting pin. The connection plate is heated and then the connecting pin is inserted into the opening in the connection plate. Advantageously, at room temperature, the opening in the connection plate is smaller than the diameter of the connecting pin, with the result that only the heating of the connection plate, owing to the thermal expansion, brings about such an enlargement of the opening that the connecting pin can be inserted into the opening. Once the connecting pin has been inserted, the connection plate is cooled, with the result that the opening becomes smaller again and thus the connecting pin is fixed in the connection plate. In other words, the connection plate is thermally shrunk onto the connecting pin.

The proposed method enables a comparatively simple and time-saving production of the connection between the connection plate and the connecting pin in comparison with welding or riveting methods. Furthermore, apart from the two component parts to be connected, advantageously no further component parts are required for producing the connection.

In the method, the connecting pin is passed through an opening in the battery cell housing, in particular through an opening in the lid of the battery cell housing. The connecting pin is connected to the current collector on a side remote from the connection plate. The connection can take place, for example, by means of welding, for example laser welding. The steps of connecting the connecting pin to the current collector and passing the connecting pin through an opening in the battery cell housing can take place prior to or after the connection of the connecting pin to the connection plate.

Preferably, the connection plate comprises aluminum. The connecting pin preferably comprises copper. Furthermore, the current collector preferably also comprises copper. The technology is based in particular on the considerations presented hereafter: The current collector of the negative electrode of lithium-ion battery cells typically comprises copper and the current collector of the positive electrode comprises aluminum. The battery cell housing and the connection terminals of lithium-ion battery cells are typically manufactured from aluminum. In the case of the current terminal of the negative electrode, the different melting points of aluminum and copper make the production of a connection between the current collector and the connection plate by welding more difficult. The proposed method, in contrast to this, makes use of the different thermal properties of the materials at the negative terminal, where the different thermal expansion is used for producing a fixed mechanical connection. It has been found that, in this way, an electrically conductive connection with a low contact resistance can be produced. In comparison with a connection made by riveting, there is no risk of metal particles being produced during the connection process which could impair the operation of the battery cell.

In accordance with one embodiment, the heating of the connection plate to a temperature of from 250° C. to 550° C. takes place. During cooling from a temperature in this range to room temperature, a fixed mechanical connection can be produced between the connection plate and the connecting pin.

One end of the connecting pin which is remote from the connection plate is preferably connected to the current collector by means of welding. In this case, it is advantageous if both the connecting pin and the current collector comprise the same material, in particular copper. This connection can take place prior to the connection of the connecting pin to the connection plate or thereafter.

In a preferred embodiment, a current collector of at least one positive electrode (cathode) of the lithium-ion battery cell is connected to a further connecting pin, wherein the further connecting pin is formed integrally with a further connection plate, i.e., the connecting pin is part of the connection plate and comprises in particular the material of the connection plate. The current collector of the positive electrode, the connecting pin and the connection plate can each comprise aluminum. The integral design of the connecting pin and the connection plate make it possible to also connect to the current collector of the positive electrode with little complexity involved. That side of the connecting pin which is remote from the connection plate can be connected to the current collector of the positive electrode by means of welding, for example.

Also described is a lithium-ion battery cell which is produced using the above-described method. All of the configurations disclosed for the method can be implemented in the lithium-ion battery cell, and vice versa.

The lithium-ion battery cell comprises in particular a battery cell housing having a connection plate on an outer side of the battery cell housing, wherein the connection plate is connected to a current collector of a negative electrode of the battery cell by means of a connecting pin, and wherein the connection plate is shrunk onto the connecting pin. The fact that the connection plate is shrunk onto the connecting pin can be seen at the joint. In particular, the joint does not have any traces of a welding or riveting operation.

The lithium-ion battery cell is preferably a prismatic battery cell. The battery cell housing can have, for example, a rectangular base and can be substantially in the form of a rectangular parallelepiped. The battery cell housing can have, for example, a base wall, side walls and a lid. Prismatic battery cells can advantageously be easily stacked and combined to form a battery module. The battery cell housing can comprise a metal or a metal alloy, for example aluminum. It is possible for the battery cell housing to be provided, at least in part, with an electrically insulating layer.

Also described is a lithium-ion battery having a plurality of the lithium-ion battery cells described herein. The lithium-ion battery cells described herein can advantageously be used in a lithium-ion battery which can be used in particular as a traction battery in an electrically driven motor vehicle.

### BRIEF DESCRIPTION OF THE DRAWINGS

In the text which follows, a preferred exemplary embodiment of the disclosure is described with reference to the figures. These provide further details, preferred embodiments and developments of the invention. Specifically,

FIG. 1 shows, schematically, a perspective illustration of a battery cell housing of the lithium-ion battery cell in accordance with one exemplary embodiment, and

FIG. 2 shows, schematically, a detail view of the region of the lid of the lithium-ion battery cell in an exploded illustration.

Identical or functionally identical component parts are provided in each case with the same reference symbols in the figures. The component parts illustrated and the size ratios of the component parts in relation to one another should not be regarded as being true to scale.

### DETAILED DESCRIPTION OF THE DRAWINGS

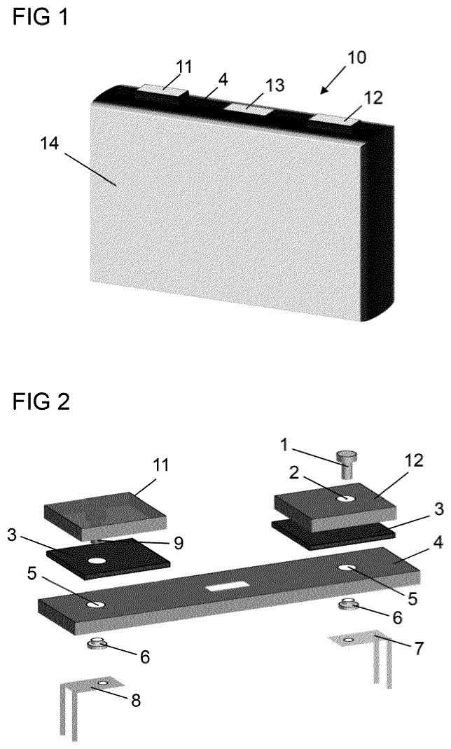

The battery cell 10 illustrated schematically in FIG. 1 is a prismatic battery cell in the exemplary embodiment shown here. The battery cell 10 has a battery cell housing 14, which forms a mechanically fixed jacket for at least one electrode unit of the battery cell 10. The at least one electrode unit can be present in the battery cell 10 in the form of, for example, an electrode stack or electrode coil. The battery cell housing 14 has, in the exemplary embodiment, a rectangular base and is substantially in the form of a rectangular parallelepiped. The battery cell housing 14 can be formed from a metal or a metal alloy, preferably from aluminum. It is possible for the battery cell housing 14 to have, at least in part, an electrically insulating coating. The battery cell 10 has connection plates 11, 12, which form a positive terminal and a negative terminal of the battery cell 10. The connection plates 11, 12 are arranged, for example, on a lid 4 of the battery cell housing 14. The connection plates 11, 12 are provided for making electrical contact with the poles of the electrode stack or electrode coil of the battery cell 10. FIG. 1 furthermore shows a cover 13 arranged on the lid 4 of the battery cell housing 14, which cover 13 is arranged, for example, in the region between the connection plates 11, 12. An overpressure safety device such as, for example, a bursting membrane can be arranged under the cover 13.

FIG. 2 shows, in an exploded illustration, details in the region of the lid 4 of the battery cell 10. The positive terminal of the battery cell is formed by a connection plate 11, and the negative terminal is formed by a connection plate 12. The connection plates are each arranged on an outer side of the lid 4 and are insulated from the lid by means of an electrically insulating plate 3. The connection plate 12 is electrically connected to the current collector 7 of the negative electrode (anode) of the battery cell by a connecting pin 1. The material of the connection plate 12 has a higher coefficient of thermal expansion than the connecting pin 1. The connecting pin 1 and the current collector 7 preferably each comprise or consist of copper. The connection plate 12 and the battery cell housing 14 including the lid 4 preferably each comprise or consist of aluminum. The connection plate 12 is connected thermally to the connecting pin 1 during the production of the battery cell. The connection plate 12 is heated, preferably to a temperature in the range of from 250° C. to 550° C. The connecting pin 1 is then inserted into an opening 2 in the connection plate 12, and then the connection plate 12 is cooled, wherein the connecting pin 1 is fixed in the connection plate 12 by means of the thermal shrinkage of the connection plate 12 during cooling. The connection plate 12 is therefore shrunk onto the connecting pin 1. One side of the connecting pin 1 which is remote from the connection plate 12 is passed through an opening 5 in the lid 4 of the battery cell housing and connected to the current collector 7, for example by means of welding. A seal 6 can be inserted between the lid 4 and the connecting pin 1 in order to seal off the battery cell.

The current collector 8 of the positive electrode is connected to a further connection plate 11 by means of a further connecting pin 9. Since aluminum in the case of a lithium-ion battery cell is suitable as the material for the current collector 8 of the positive electrode, on this side the current collector 8, the connecting pin 9 and the connection plate 11 can comprise or consist of aluminum. Preferably, the connecting pin 9 is formed integrally with the connection plate 11. In this case, the connection process between the connection plate 11 and the connecting pin 9 can advantageously be dispensed with and now only that end of the connecting pin 9 which is remote from the connection plate 11 is connected to the current collector 8.

In this way, the lithium-ion battery cell can be produced with a low level of complexity and in a time-saving manner. This is particularly advantageous for lithium-ion battery cells which are inserted in a lithium-ion battery of an electrically driven motor vehicle. Since lithium-ion batteries in motor vehicles have a multiplicity of battery cells, time savings in the production of an individual battery cell result in considerable cost advantages.

Although the invention has been illustrated and described in detail with reference to exemplary embodiments, the invention is not restricted by the exemplary embodiments. Instead, other variations of the invention can be derived herefrom by a person skilled in the art without departing from the scope of protection of the invention as defined by the claims.

### LIST OF REFERENCE SYMBOLS

1 connecting pin
2 opening in connection plate
3 insulating plate
4 lid of battery cell housing
5 opening in lid
6 seal
7 current collector of negative electrode
8 current collector of positive electrode
9 connecting pin
10 battery cell
11 connection plate (positive terminal)
12 connection plate (negative terminal)
13 cover for bursting membrane
14 battery cell housing

1-10. (canceled)

11. A method for producing a lithium-ion battery cell, the method comprising:
providing a connecting pin and a connection plate of a battery cell housing of the lithium-ion battery cell, the connection plate having an opening for the connecting pin and comprising a higher coefficient of thermal expansion than the connecting pin;
heating the connection plate;
inserting the connecting pin into the opening in the connection plate and cooling the connection plate, thereby fixing the connecting pin in the connection plate;
passing the connecting pin through an opening in the battery cell housing; and
connecting the connecting pin to a current collector of at least one negative electrode of the lithium-ion battery cell, thereby electrically connecting the current collector to the connection plate.

12. The method according to claim 11,
wherein the connection plate comprises aluminum, and the connecting pin comprises copper.

13. The method according to claim 11,
wherein the current collector of the at least one negative electrode comprises copper.

14. The method according to claim 11,
wherein the connection plate is heated to a temperature in a range from 250° C. to 550° C.

15. The method according to claim 11,
wherein the connecting pin is connected to the current collector by welding.

16. The method according to claim 11,
wherein a current collector of at least one positive electrode of the lithium-ion battery cell is connected to a further connecting pin.

17. The method according to claim 16, wherein the further connecting pin is integrally formed with a further connection plate.

18. The method according to claim 17, wherein the further connecting pin and the further connection plate comprise aluminum.

19. The method according to claim 16, wherein the current collector of the at least one positive electrode comprises aluminum.

20. A lithium-ion battery cell comprising:
a battery cell housing;
a connection plate on an outer side of the battery cell housing; and
a connecting pin connecting a current collector of a negative electrode of the lithium-ion battery cell to the connection plate,
wherein the connection plate is shrunk onto the connecting pin.

21. The lithium-ion battery cell according to claim 20,
wherein a joint between the connection plate and the connecting pin does not have any traces of a welding or riveting operation.

22. The lithium-ion battery cell according to claim 20,
wherein the connection plate comprises aluminum, and the connecting pin comprises copper.

23. The lithium-ion battery cell according to claim 20,
wherein the current collector of the negative electrode comprises copper.

24. The lithium-ion battery cell according to claim 20, further comprising:
a current collector of at least one positive electrode of the lithium-ion battery cell; and
a further connecting pin connected to the current collector of the at least one positive electrode, the further connecting pin being integrally formed with a further connection plate.

25. The lithium-ion battery cell according to claim 24,
wherein the current collector of the at least one positive electrode, the further connecting pin, and the further connection plate comprise aluminum.

26. A lithium-ion battery comprising a plurality of the lithium-ion battery cells according to claim 20.
